(19) United States
(12) Patent Application Publication
(10) Pub. No.: US 2019/0112078 A1
(43) Pub. Date: Apr. 18, 2019

(54) MULTIFACETED INSTRUMENT CONSOLE

(71) Applicant: The Boeing Company, Chicago, IL (US)

(72) Inventors: Jonnathan O. Medina-Espitia, Houston, TX (US); Debra Sue Owen, Houston, TX (US); Christopher Ferguson, Cape Canaveral, FL (US); Xavier D. Simon, Aliso Viejo, CA (US); Stephen S. Gauvain, Houston, TX (US)

(21) Appl. No.: 15/783,950

(22) Filed: Oct. 13, 2017

(51) Int. Cl. B64G 1/60; B64G 1/12; B64G 1/66

(52) U.S. Cl. CPC B64G 1/60; B64G 1/66; B64G 1/12

(57) ABSTRACT

A multifaceted instrument console for use by an operator. In one embodiment, an instrument console for a vehicle comprises a primary mounting surface positioned directly in front of an operator of the vehicle, and a plurality of auxiliary mounting surfaces each being contiguous with the primary mounting surface or another one of the auxiliary mounting surfaces. Each of the auxiliary mounting surfaces is angled with respect to a contiguous mounting surface toward the operator.

### STATEMENT REGARDING FEDERALLY SPONSORED RESEARCH OR DEVELOPMENT

This invention was made with government support under contract numbers NNK11MS03S and NNK12MS01S awarded by NASA. The government has certain rights in the invention.

### FIELD

This disclosure relates to the field of instrument consoles for vehicles, such as aircraft or spacecraft.

### BACKGROUND

The instrument console of a vehicle provides an operator with information regarding the operation of the vehicle, and allows the operator to control the vehicle. For example, the instrument console for an aircraft may include an altimeter, an airspeed indicator, a compass, an attitude indicator, a heading indicator, warning lights, etc. The instrument console for an aircraft may also include switches, buttons, levers, or other controls.

Some traditional instrument consoles are flat with instruments spread out along the surface area of the flat console. One problem with flat consoles is that instruments at the center are easy to reach by operators of varying sizes, but instruments toward the sides of the flat console may be hard to reach, especially for smaller operators. To centralize many instruments toward the center of a flat console, all-digital or mostly-digital interfaces may replace physical gauges, switches, buttons, etc. However, digital interfaces are time consuming to operate by paging through screens, and high priority instruments may not be immediately accessible to an operator. Also, digital interfaces may by inoperable in extreme environments, such as when smoke is present, in rough conditions, etc.

### SUMMARY

Embodiments described herein provide for an improved instrument console for a vehicle, such as an aircraft, a spacecraft, or other human operated vehicles with complex interfaces. The instrument console as described herein is comprised of multiple mounting surfaces or facets that are turned toward the operator. Due to this multifaceted design, control interfaces mounted on the instrument console are within reach of the operator. The size and arrangement of mounting surfaces has been analyzed and optimized so that a very wide variety of operators are able to reach the control interfaces. As part of the design, a large mounting surface is positioned directly ahead of the operator's Design Eye Point (DEP) as a primary location for the highest priority interfaces. Other mounting surfaces are angled toward the operator. Control interfaces mounted on these mounting surfaces are advantageously within reach of the operator, even during an extreme environment. This instrument console also provides an open volume with no mounting surfaces in order to allocate space for an external window, while maximizing the surface area available for control interfaces.

One embodiment comprises an instrument console for a vehicle. The instrument console comprises a primary mounting surface positioned directly in front of an operator of the vehicle, and a plurality of auxiliary mounting surfaces each being contiguous with the primary mounting surface or another one of the auxiliary mounting surfaces. Each of the auxiliary mounting surfaces is angled with respect to a contiguous mounting surface toward the operator.

In another embodiment, a first one of the auxiliary mounting surfaces is contiguous with a top side of the primary mounting surface. The instrument console further comprises an opening above the first one of the auxiliary mounting surfaces to provide a view of an external window of the vehicle to the operator.

In another embodiment, a second one of the auxiliary mounting surfaces is contiguous with a left side of the primary mounting surface, a third one of the auxiliary mounting surfaces is contiguous with a right side of the primary mounting surface, a fourth one of the auxiliary mounting surfaces is contiguous with a top side of the third one of the auxiliary mounting surfaces, and a fifth one of the auxiliary mounting surfaces is contiguous with a top side of the fourth one of the auxiliary mounting surfaces.

In another embodiment, the instrument console further comprises priority control interfaces mounted on the primary mounting surface and the first one of the auxiliary mounting surfaces that are used for primary control of the vehicle, and supplementary control interfaces mounted on second ones of the auxiliary mounting surfaces that are used for secondary functions of the vehicle as opposed to primary control.

In another embodiment, a second one of the auxiliary mounting surfaces is contiguous with a right side of the primary mounting surface, a third one of the auxiliary mounting surfaces is contiguous with a left side of the primary mounting surface, a fourth one of the auxiliary mounting surfaces is contiguous with a top side of the third one of the auxiliary mounting surfaces, and a fifth one of the auxiliary mounting surfaces is contiguous with a top side of the fourth one of the auxiliary mounting surfaces.

Another embodiment comprises an instrument console for a vehicle. The instrument console comprises a plurality of console sections that includes a primary console section having a primary mounting surface positioned directly in front of an operator of the vehicle, and configured for mounting of priority control interfaces that are used for primary control of the vehicle. The plurality of console sections further includes a first auxiliary console section having a first auxiliary mounting surface contiguous with a top side of the primary mounting surface, and oriented at a first angle in relation to the primary mounting surface toward the operator. The plurality of console sections further includes a second auxiliary console section having a second auxiliary mounting surface contiguous with a first side of the primary mounting surface, and oriented at a second angle in relation to the primary mounting surface toward the operator. The plurality of console sections further includes a third auxiliary console section having a third auxiliary mounting surface contiguous with a second side of the primary mounting surface, and oriented at a third angle in relation to the primary mounting surface toward the operator. The plurality of console sections further includes a fourth auxiliary console section having a fourth auxiliary mounting surface contiguous with a top side of the third auxiliary mounting surface, and oriented at a fourth angle in relation to the third auxiliary mounting surface toward the operator. The plurality of console sections further includes a fifth auxiliary console section having a fifth auxiliary mounting surface contiguous with a top side of the fourth auxiliary mounting surface, and oriented at a fifth angle in relation to the fourth auxiliary mounting surface toward the operator.

In another embodiment, the first auxiliary mounting surface is configured for mounting of the priority control interfaces.

In another embodiment, the primary mounting surface and at least a portion of the first auxiliary mounting surface are within a cone of vision of the operator.

In another embodiment, the second auxiliary mounting surface, the third auxiliary mounting surface, the fourth auxiliary mounting surface, and the fifth auxiliary mounting surface are configured for mounting of supplementary control interfaces used for secondary functions of the vehicle as opposed to primary control.

In another embodiment, the first angle between the first auxiliary mounting surface and the primary mounting surface is in a range of 35°±3°.

In another embodiment, the second angle between the second auxiliary mounting surface and the primary mounting surface is in a range of 40°±3°.

In another embodiment, the third angle between the third auxiliary mounting surface and the primary mounting surface is in a range of 20°±3°.

In another embodiment, the fourth angle between the fourth auxiliary mounting surface and the third auxiliary mounting surface is in a range of 35°±3°.

In another embodiment, the fifth angle between the fifth auxiliary mounting surface and the fourth auxiliary mounting surface is in a range of 30°±3°.

In another embodiment, the instrument console further comprises an opening above the first auxiliary console section and to a side of the fifth auxiliary console section that exposes an external window of the vehicle.

In another embodiment, a top border of the first auxiliary console section and a side border of the fifth auxiliary console section defines at least a portion of a boundary of the opening.

In another embodiment, the vehicle comprises a spacecraft.

Another embodiment comprises a spacecraft comprising a seat mounted in a compartment of the spacecraft, an external window, and an instrument console mounted in the compartment of the spacecraft and having a plurality of mounting surfaces configured for mounting of control interfaces. The mounting surfaces include a primary mounting surface positioned directly in front of a Design Eye Point (DEP) of an operator sitting in the seat, and a plurality of auxiliary mounting surfaces each being contiguous with the primary mounting surface or another one of the auxiliary mounting surfaces. Each of the auxiliary mounting surfaces is angled with respect to a contiguous mounting surface toward the operator. The instrument console includes an opening that exposes the external window.

In another embodiment, the auxiliary mounting surfaces comprise a first auxiliary mounting surface contiguous with a top side of the primary mounting surface, and oriented at a first angle in relation to the primary mounting surface toward the operator. The auxiliary mounting surfaces comprise a second auxiliary mounting surface contiguous with a first side of the primary mounting surface, and oriented at a second angle in relation to the primary mounting surface toward the operator. The auxiliary mounting surfaces comprise a third auxiliary mounting surface contiguous with a second side of the primary mounting surface, and oriented at a third angle in relation to the primary mounting surface toward the operator. The auxiliary mounting surfaces comprise a fourth auxiliary mounting surface contiguous with a top side of the third auxiliary mounting surface, and oriented at a fourth angle in relation to the third auxiliary mounting surface toward the operator. The auxiliary mounting surfaces comprise a fifth auxiliary mounting surface contiguous with a top side of the fourth auxiliary mounting surface, and oriented at a fifth angle in relation to the fourth auxiliary mounting surface toward the operator.

In another embodiment, the opening is above the first auxiliary mounting surface and to a side of the fifth auxiliary mounting surface to expose the external window.

The features, functions, and advantages that have been discussed can be achieved independently in various embodiments or may be combined in yet other embodiments, further details of which can be seen with reference to the following description and drawings.

### DESCRIPTION OF THE DRAWINGS

Some embodiments of the present invention are now described, by way of example only, with reference to the accompanying drawings. The same reference number represents the same element or the same type of element on all drawings.

FIG. 1 is a schematic view of an instrument console in an illustrative embodiment.

FIG. 2 is an isometric view of an instrument console in an illustrative embodiment.

FIG. 3 is a side view of an instrument console in an illustrative embodiment.

FIG. 4 is a bottom view of an instrument console in an illustrative embodiment.

FIG. 5 is a side view of an instrument console in an illustrative embodiment.

FIG. 6 is a schematic view of an instrument console in another illustrative embodiment.

FIG. 7 illustrates a spacecraft in an illustrative embodiment.

FIG. 8 is an interior view of a spacecraft in an illustrative embodiment.

FIG. 9 is a side view of an operator's compartment in a spacecraft in an illustrative embodiment.

FIG. 10 is another view of an operator's compartment in a spacecraft in an illustrative embodiment.

FIGS. 11-12 illustrate a reach of an operator in relation to an instrument console in an illustrative embodiment.

### DETAILED DESCRIPTION

The figures and the following description illustrate specific exemplary embodiments. It will be appreciated that those skilled in the art will be able to devise various arrangements that, although not explicitly described or shown herein, embody the principles described herein and are included within the contemplated scope of the claims that follow this description. Furthermore, any examples described herein are intended to aid in understanding the principles of the disclosure, and are to be construed as being without limitation. As a result, this disclosure is not limited to the specific embodiments or examples described below, but by the claims and their equivalents.

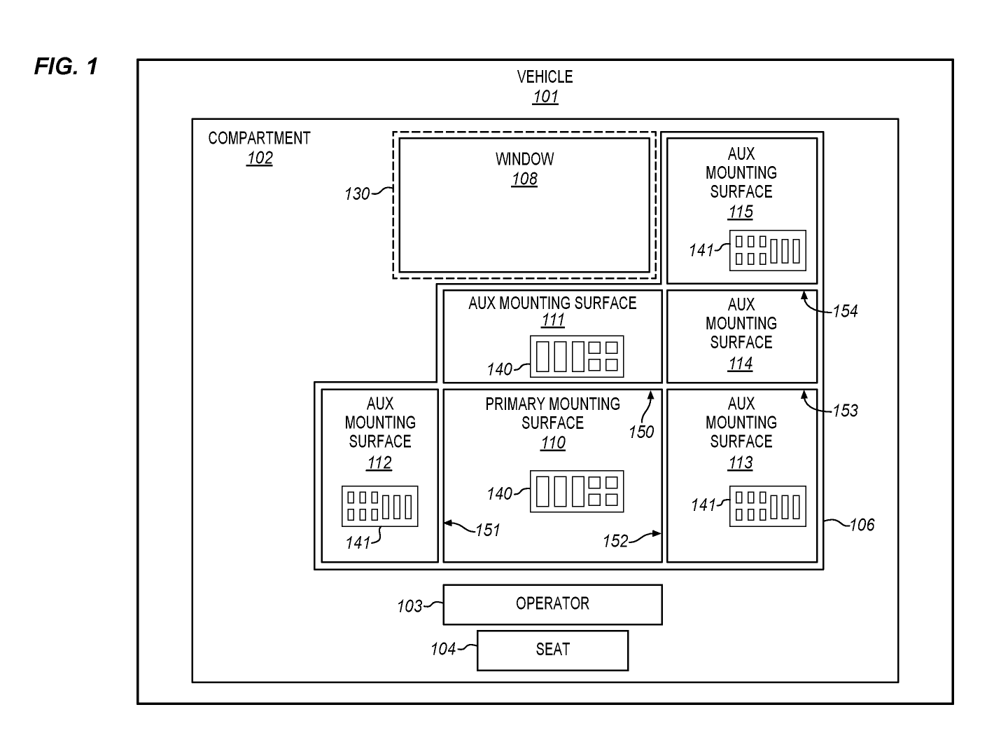

FIG. 1 is a schematic view of an instrument console 100 in an illustrative embodiment. Instrument console 100 is shown as part of a vehicle 101, which represents any type of manned apparatus used for conveyance, such as an aircraft, a spacecraft, a watercraft, a land-based vehicle, etc. Vehicle 101 has a cab, cabin, capsule, or other type of compartment 102 where an operator 103 (i.e., a human operator) is able to control vehicle 101. Compartment 102 includes a seat 104 where the operator 103 sits when controlling vehicle 101. Instrument console 100 represents a control panel apparatus positioned in front of operator 103 (or multiple operators), which houses instruments and controls for the vehicle's operation. Instruments, such as gauges, meters, indicators, displays, etc., and controls, such as dials, buttons, switches, levels, sticks, etc., are collectively referred to herein as control interfaces.

To properly control vehicle 101, a minimum number of control interfaces may be specified by designers of vehicle 101. However, the size of compartment 102 may put a constraint on the overall surface area of instrument console 100. Another constraint may be that all of the control interfaces mounted on/in instrument console 100 be within reach of operator 103. In consideration of the above and other constraints, instrument console 100 is designed with an overall surface area 106 for mounting of the control interfaces. In order to put the control interfaces within reach of operator 103, the overall surface area 106 of instrument console 100 is segmented into a plurality of mounting surfaces 110-115 (also referred to as facets or faces). Mounting surfaces 110-115 are configured for mounting or installation of control interfaces, which means that mounting surfaces 110-115 have an appropriate size and/or contour for fitting of control interfaces, have holes or cut-outs in an appropriate pattern for mounting of control interfaces, etc. Mounting surfaces 110-115 include a primary mounting surface 110 positioned directly in front of operator 103, and a plurality of auxiliary mounting surfaces 111-115. Primary mounting surface 110 is a large surface area directly in front of operator 103 that is used for mounting higher priority control interfaces. Auxiliary mounting surfaces 111-115 are each contiguous with primary mounting surface 110 or another one of the auxiliary mounting surfaces 111-115. For example, auxiliary mounting surface 111 is contiguous with a top side 150 of primary mounting surface 110. Auxiliary mounting surface 112 is contiguous with a left side 151 of primary mounting surface 110. Auxiliary mounting surface 113 is contiguous with a right side 152 of primary mounting surface 110. Auxiliary mounting surface 114 is contiguous with a top side 153 of auxiliary mounting surface 113. Auxiliary mounting surface 115 is contiguous with a top side 154 of auxiliary mounting surface 114.

Each auxiliary mounting surface 111-115 is angled with respect to a contiguous mounting surface toward operator 103, which will be described in further detail below. As an example, auxiliary mounting surface 111 is angled with respect to primary mounting surface 110 toward operator 103. Auxiliary mounting surface 112 is angled with respect to primary mounting surface 110 toward operator 103. Auxiliary mounting surface 113 is angled with respect to primary mounting surface 110 toward operator 103. Auxiliary mounting surface 114 is angled with respect to auxiliary mounting surface 113 toward operator 103. Auxiliary mounting surface 115 is angled with respect to auxiliary mounting surface 114 toward operator 103. Because auxiliary mounting surfaces 111-115 are angled in this manner, primary mounting surface 110 and auxiliary mounting surfaces 111-115 provide a platform to layout the control interfaces in an effective manner to operator 103 where all of the control interfaces are within reach of operator 103. The control interfaces as described herein may be categorized as “priority” control interfaces and “supplementary” control interfaces. Priority control interfaces refer to the control interfaces used for primary control or operation of vehicle 101. For example, in an aircraft or spacecraft, the priority control interfaces may include caution, warning, or emergency indicators, primary flight controls, a primary display, a combined ordnance panel, a primary control panel, a backup engage panel, etc. One or more of the priority control interfaces are physical interfaces that are manually moved, such as a switch, a button, lever, etc., as opposed to a digital only interface which requires an operator to cycle through menus. Supplementary control interfaces refer to the control interfaces used for secondary functions of the vehicle as opposed to primary control. Examples of supplementary control interfaces include temperature controls, radio controls, lighting controls, a secondary display, etc. As shown in FIG. 1, priority control interfaces 140 are mounted on primary mounting surface 110, as this surface is positioned directly in front of operator 103. Priority control interfaces 140 may also be mounted on auxiliary mounting surface 111 along with supplementary control interfaces 141. Supplementary control interfaces 141 are mounted on auxiliary mounting surfaces 112-115.

Yet another constraint for designers of instrument console 100 may be to incorporate a live external view to operator 103 out of an exterior or external window 108 of vehicle. In one embodiment, the shape or structure of instrument console 100 defines an opening 130 above auxiliary mounting surface 111 to allow operator 103 to view external window 108. Opening 130 is an area above auxiliary mounting surface 111 and to the side (e.g., to the left) of auxiliary mounting surface 115, that is devoid of the structural elements of instrument console 100 to expose external window 108 so that operator 103 has an unobstructed view outside of vehicle 101 through external window 108.

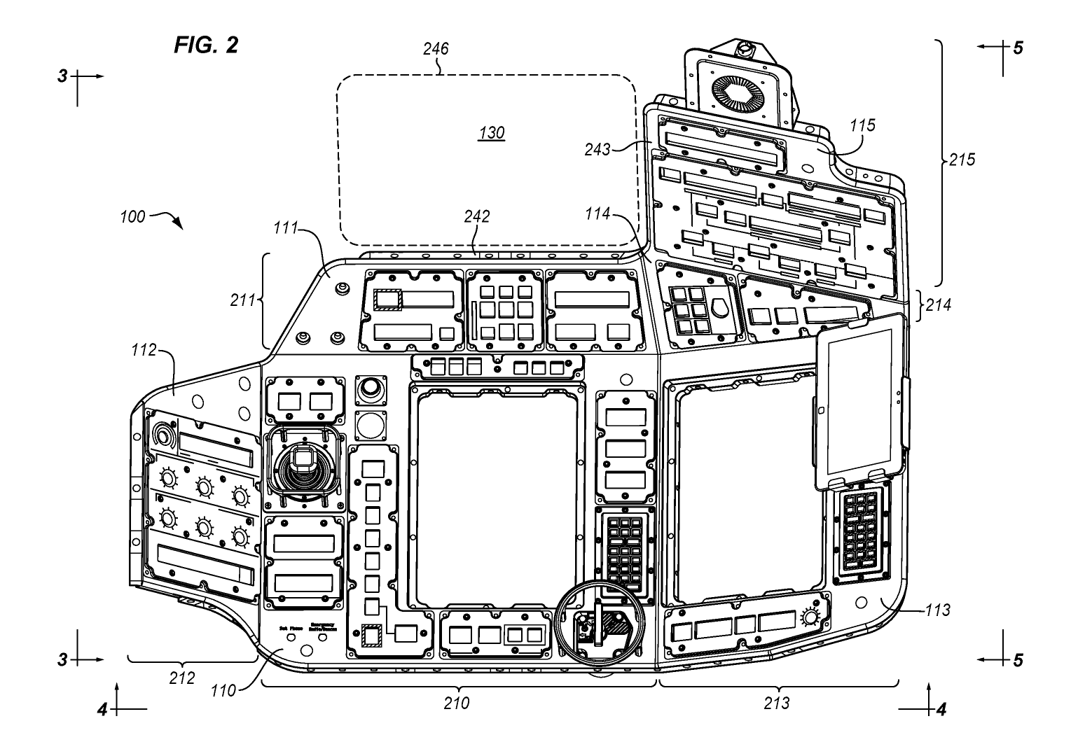

FIG. 2 is an isometric view of an instrument console 100 in an illustrative embodiment. FIG. 2 further illustrates structural elements of instrument console 100. Instrument console 100 is comprised of multiple console sections 210-215 that include mounting surfaces 110-115, respectively. Primary console section 210 is positioned directly in front of operator 103, and includes primary mounting surface 110. Primary mounting surface 110 is positioned directly ahead of the operator's Design Eye Point (DEP) as a primary location for priority control interfaces 140. Priority control interfaces 140 are therefore within the field of view of operator 103 when the operator's eyes coincide with the DEP, and the operator's body, head, and eyes are at a neutral position. In some vehicles, such as spacecraft, seat adjustability may be limited to operator 103. In such instances, primary mounting surface 110 is positioned with the DEP of operator 103 as a reference point, with priority control interfaces 140 within the field of view of operator 103. Primary mounting surface 110 may be tilted away (i.e., from bottom to top) from operator 103 at an angle in relation to the vertical plane of seat 104.

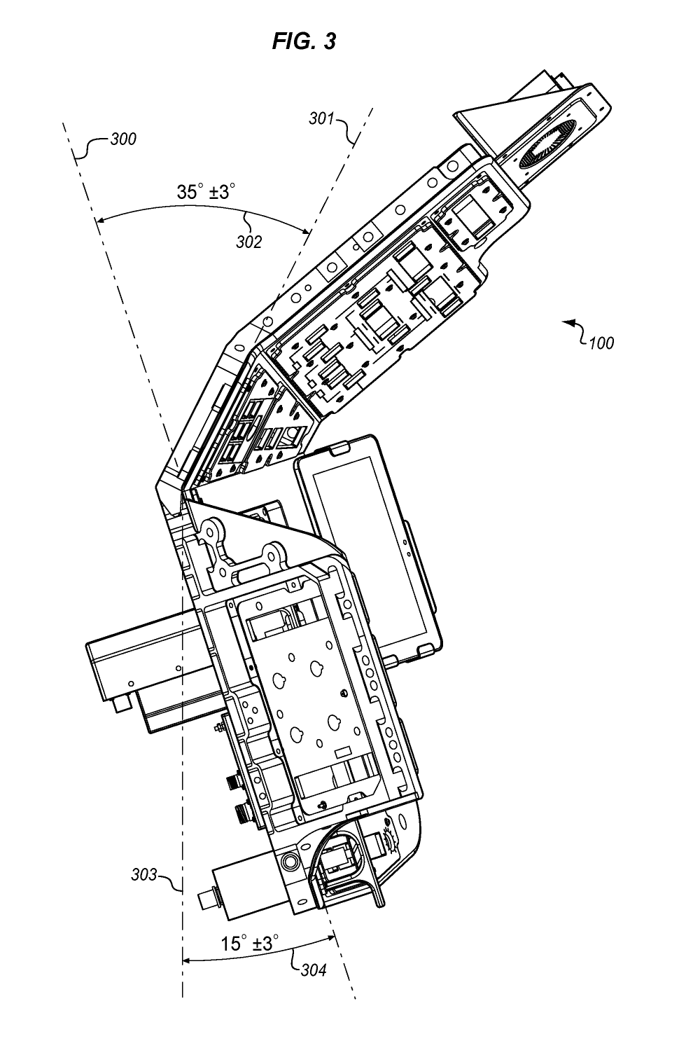

An auxiliary console section 211 is positioned or arranged on a top side of primary console section 210, and includes auxiliary mounting surface 111. Auxiliary mounting surface 111 is contiguous with primary mounting surface 110 (i.e., top side 150 of primary mounting surface 110), and is oriented at an angle in relation to primary mounting surface 110 toward operator 103. At least a portion of auxiliary mounting surface 111 may be in the field of view of operator 103, which means that priority control interfaces 140 may be mounted on this portion of auxiliary mounting surface 111. FIG. 3 is a side view of instrument console 100 in an illustrative embodiment. The view of instrument console 100 in FIG. 3 is from view arrows 3-3 shown in FIG. 2. Line 300 represents the surface plane of primary mounting surface 110, and line 301 represents the surface plane of auxiliary mounting surface 111. In this embodiment, the angle 302 between auxiliary mounting surface 111 and primary mounting surface 110 may be in the range of 35°±3°, although angle 302 may vary as desired in other embodiments. As described above, primary mounting surface 110 may be tilted away (i.e., from bottom to top) from operator 103. Line 303 represents a plane parallel to the plane of seat 104 (not shown in FIG. 3). The plane of seat 104 may be defined by the plane of the seat back, and line 303 is parallel to the plane of the seat back. In this embodiment, the angle 304 between primary mounting surface 110 and the plane parallel to the plane of seat 104 may be in the range of 15°±3°, although angle 304 may vary as desired in other embodiments.

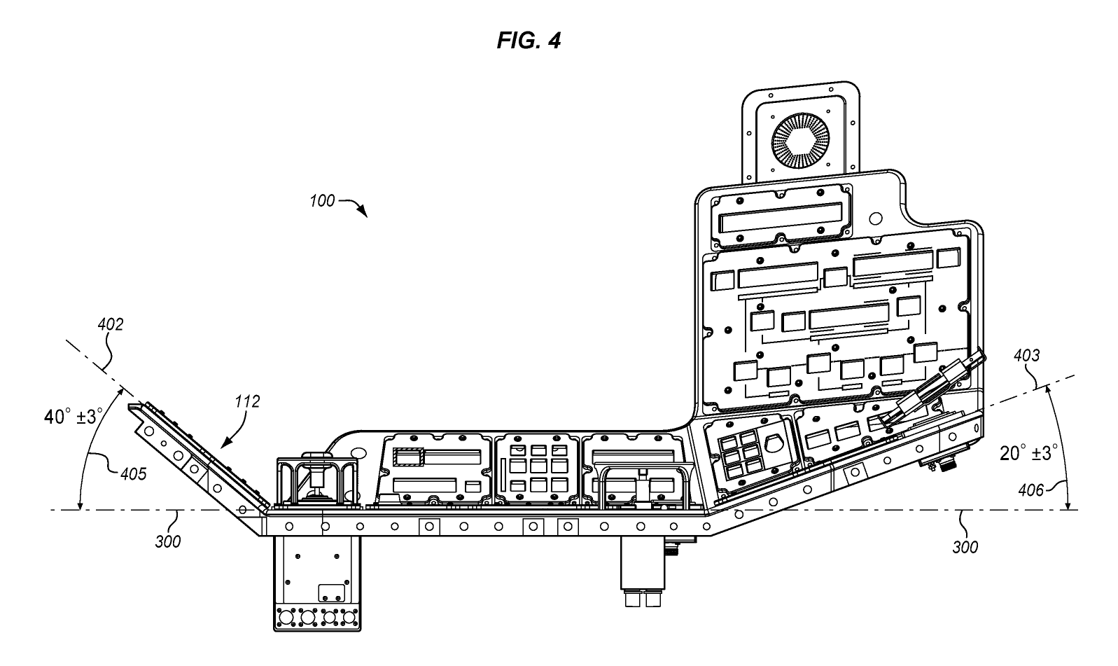

In FIG. 2, an auxiliary console section 212 is positioned or arranged on a left-hand side of primary console section 210, and includes auxiliary mounting surface 112. Auxiliary mounting surface 112 is contiguous with primary mounting surface 110 (i.e., left side 151 of primary mounting surface 110), and is oriented at an angle in relation to primary mounting surface 110 toward operator 103. FIG. 4 is a bottom view of instrument console 100 in an illustrative embodiment. The view of instrument console 100 in FIG. 4 is from view arrows 4-4 shown in FIG. 2. Line 300 represents the surface plane of primary mounting surface 110, and line 402 represents the surface plane of auxiliary mounting surface 112. In this embodiment, the angle 405 between auxiliary mounting surface 112 and primary mounting surface 110 may be in the range of 40°±3°, although angle 405 may vary as desired in other embodiments.

In FIG. 2, an auxiliary console section 213 is positioned or arranged on a right-hand side of primary console section 210, and includes auxiliary mounting surface 113. Auxiliary mounting surface 113 is contiguous with primary mounting surface 110 (i.e., right side 152 of primary mounting surface 110), and is oriented at an angle in relation to primary mounting surface 110 toward operator 103. In FIG. 4, line 403 represents the surface plane of auxiliary mounting surface 113, and line 300 again represents the surface plane of primary mounting surface 110. In this embodiment, the angle 406 between auxiliary mounting surface 113 and primary mounting surface 110 may be in the range of 20°±3°, although angle 406 may vary as desired in other embodiments.

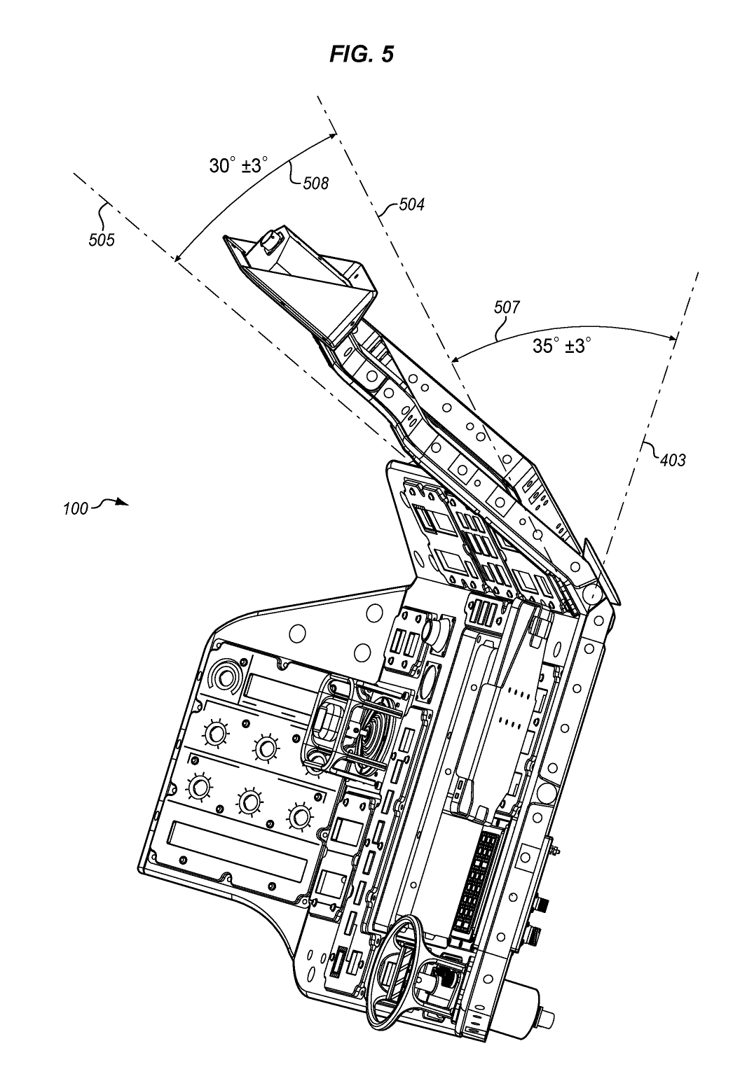

In FIG. 2, auxiliary console sections 214-215 are positioned or arranged on a top side of auxiliary console section 213. Auxiliary console section 214 includes auxiliary mounting surface 114, and auxiliary console section 215 includes auxiliary mounting surface 115. Auxiliary mounting surface 114 is contiguous with auxiliary mounting surface 113 (i.e., top side 153 of auxiliary mounting surface 113), and is oriented at an angle in relation to auxiliary mounting surface 113 toward operator 103. FIG. 5 is a side view of instrument console 100 in an illustrative embodiment. The view of instrument console 100 in FIG. 5 is from view arrows 5-5 shown in FIG. 2. Line 403 represents the surface plane of auxiliary mounting surface 113, and line 504 represents the surface plane of auxiliary mounting surface 114. In this embodiment, the angle 507 between auxiliary mounting surface 114 and auxiliary mounting surface 113 may be in the range of 35°±3°, although angle 507 may vary as desired in other embodiments.

In FIG. 2, auxiliary mounting surface 115 is contiguous with auxiliary mounting surface 114 (i.e., top side 154 of auxiliary mounting surface 114), and is oriented at an angle in relation to auxiliary mounting surface 114 toward operator 103. In FIG. 5, line 505 represents the surface plane of auxiliary mounting surface 115, and line 504 again represents the surface plane of auxiliary mounting surface 114. The angle 508 between auxiliary mounting surface 115 and auxiliary mounting surface 114 may be in the range of 30°±3°, although angle 508 may vary as desired in other embodiments.

In the above embodiments, one or more of mounting surfaces 110-115 are flat or substantially flat. In other embodiments, one or more of mounting surfaces 110-115 may be slightly rounded or curved.

FIG. 2 further illustrates opening 130 above auxiliary console section 211 and to the side (e.g., to the left) of auxiliary console section 215, that is devoid of the structural elements of instrument console 100 so that operator 103 can see through external window 108. In this embodiment, auxiliary console section 211 has a top border 242 and auxiliary console section 215 has a side border 243. The boundary 246 of opening 130 is defined, at least in part, by top border 242 of auxiliary console section 211 and side border 243 of auxiliary console section 215. The area above top border 242 of auxiliary console section 211 and to the side (i.e., to the left) of side border 243 of auxiliary console section 215 is open to external window 108 (see FIG. 1) so that operator 103 has a clear view to external window 108 around instrument console 100. One technical benefit of having the shape or structure of instrument console 100 to define opening 130 is that operator 103 can verify readings from the control interfaces based on an external view through external window 108.

In the embodiment shown above, it may be assumed that the operator's position is pushed to the left of vehicle 101 and external window 108 is biased toward an upper-left area in front of operator 103. With this configuration, opening 130 is above auxiliary mounting surface 111 and to the left side of auxiliary mounting surface 115 to expose external window 108.

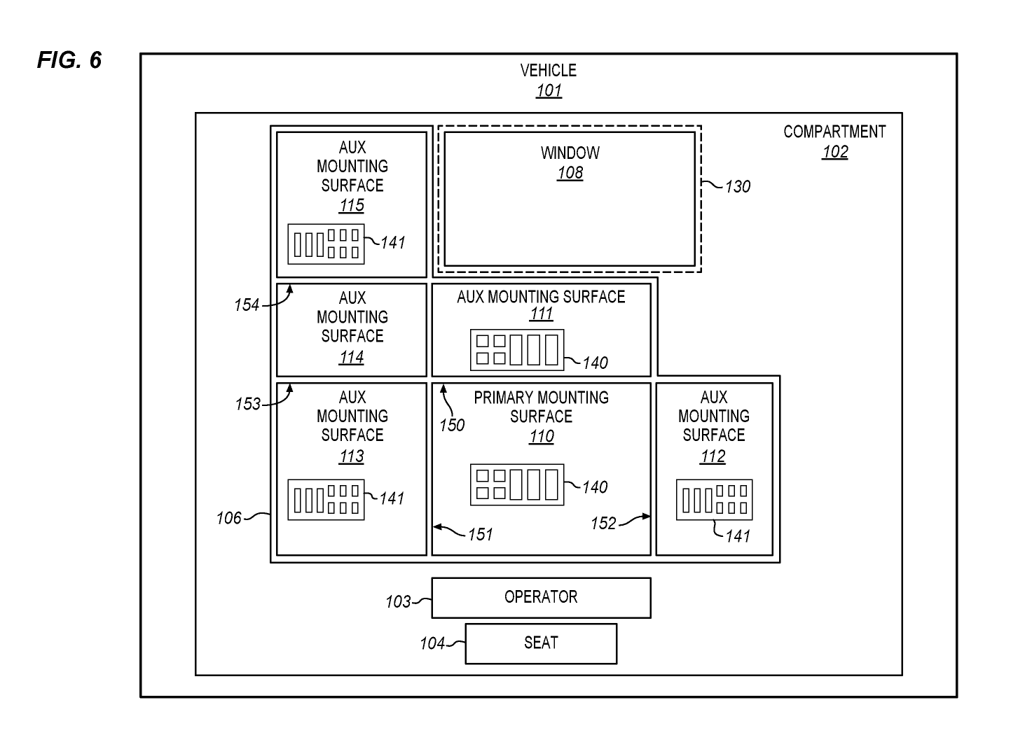

In another embodiment, mounting surfaces 110-115 may be mirrored to the configuration of instrument console 100 as shown above. FIG. 6 is a schematic view of instrument console 100 in another illustrative embodiment. In this embodiment, primary mounting surface 110 is again directly in front of operator 103. Auxiliary mounting surfaces 111-115 are each contiguous with primary mounting surface 110 or another one of the auxiliary mounting surfaces 111-115. For example, auxiliary mounting surface 111 is contiguous with a top side 150 of primary mounting surface 110. Auxiliary mounting surface 112 is contiguous with a right side 152 of primary mounting surface 110. Auxiliary mounting surface 113 is contiguous with a left side 151 of primary mounting surface 110. Auxiliary mounting surface 114 is contiguous with a top side 153 of auxiliary mounting surface 113. Auxiliary mounting surface 115 is contiguous with a top side 154 of auxiliary mounting surface 114. Each auxiliary mounting surface 111-115 is angled with respect to a contiguous mounting surface toward operator 103.

In this embodiment, the shape or structure of instrument console 100 defines opening 130 above auxiliary mounting surface 111 and to the right side of auxiliary mounting surface 115, that is devoid of the structural elements of instrument console 100 to expose external window 108 so that operator 103 has an unobstructed view outside of vehicle 101 through external window 108. It may be assumed that the operator's position is pushed to the right side of vehicle 101 and external window 108 is biased toward an upper-right area in front of operator 103. With this configuration, opening 130 is above auxiliary mounting surface 111 and to the right side of auxiliary mounting surface 115 to expose external window 108.

In one embodiment, instrument console 100 may comprise a single or unibody structural element so that mounting surfaces 110-115 are continuous at their boundaries. In another embodiment, instrument console 100 may be comprised of multiple structural elements that are fastened together within vehicle 101.

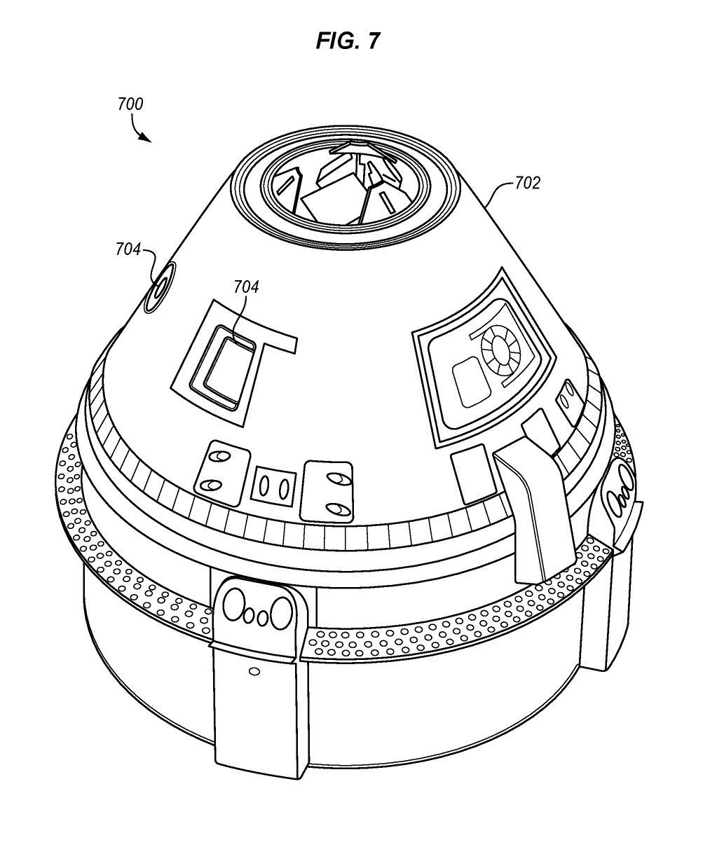

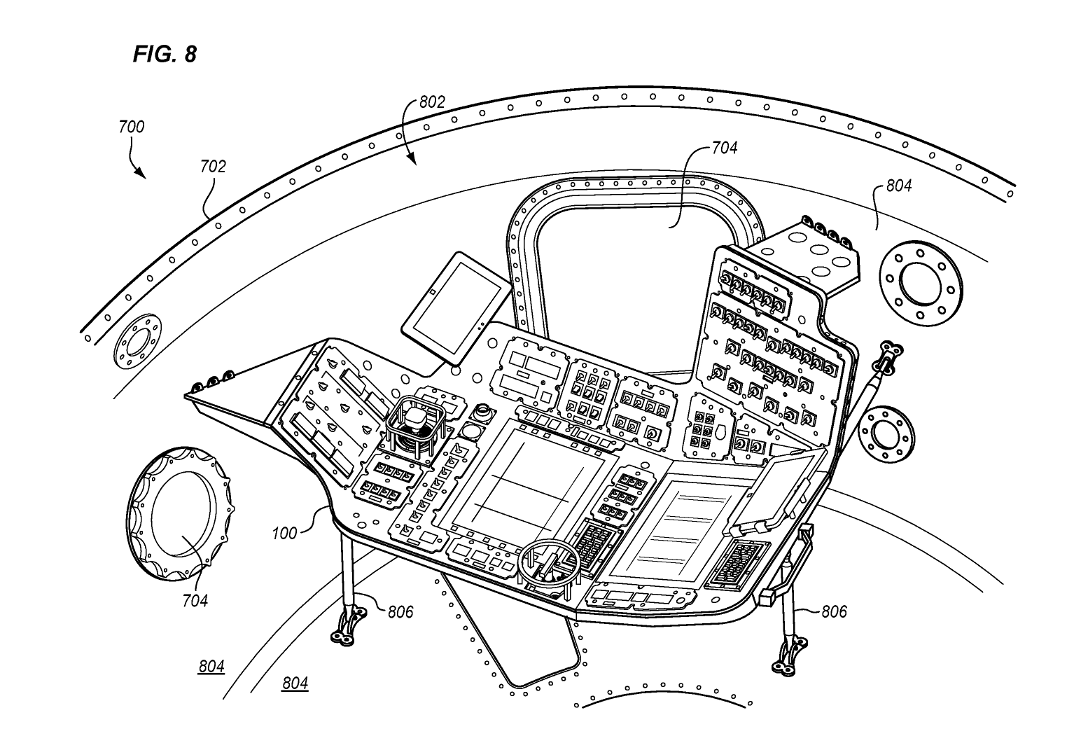

FIGS. 7-12 illustrate instrument console 100 installed in a spacecraft in one particular embodiment. FIG. 7 illustrates spacecraft 700 in an illustrative embodiment. Spacecraft 700 is a piloted vehicle designed for travel in space, such as for missions to low-orbit destinations or deep space missions. Spacecraft 700 has a fuselage 702 and one or more external windows 704. FIG. 8 is an interior view of spacecraft 700 in an illustrative embodiment. This interior view of spacecraft 700 shows the operator's compartment 802 in spacecraft 700. Instrument console 100 is mounted in compartment 802, and attached to one or more interior walls 804 of spacecraft 700. Instrument console 100 may be affixed to interior walls 804 via bolts, support members, and/or struts 806 as shown in FIG. 8. FIG. 8 also shows external windows 704 through interior walls 804 that allow an operator or operators to see outside of spacecraft 700. As described above for FIG. 1, instrument console 100 defines an opening 130 to allow the operator to view an external window 704. Thus, instrument console 100 is mounted in compartment 802 of spacecraft 700 so that the opening 130 of instrument console 100 is aligned or substantially aligned with an external window 704.

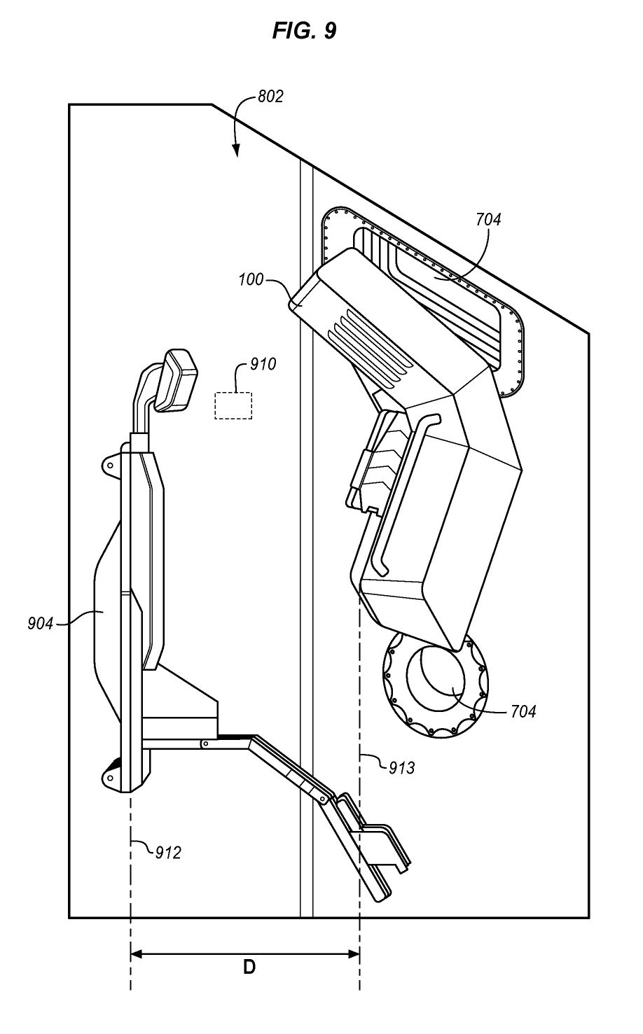

FIG. 9 is a side view of the operator's compartment 802 in spacecraft 700 in an illustrative embodiment. A seat 904 is mounted in compartment 802 in front of primary mounting surface 110 (see FIG. 1) of instrument console 100 so that an operator or pilot faces toward primary mounting surface 110. In this implementation, the position of seat 904 in relation to instrument console 100 is minimally adjustable. The seat pan is allowed to move up and down in order to bring the operator's eye position as close as possible an optimum or desired DEP 910. Line 912 illustrates the plane of seat 904, and line 913 represents a plane of the front of instrument console 100. The distance (D) of seat 904 from instrument console 100 is selected so that control interfaces on instrument console 100 are within reach of an operator from a 5th percentile female to a 95th percentile male. In this embodiment, the distance (D) may be in the range of 20.5 inches±1 inch.

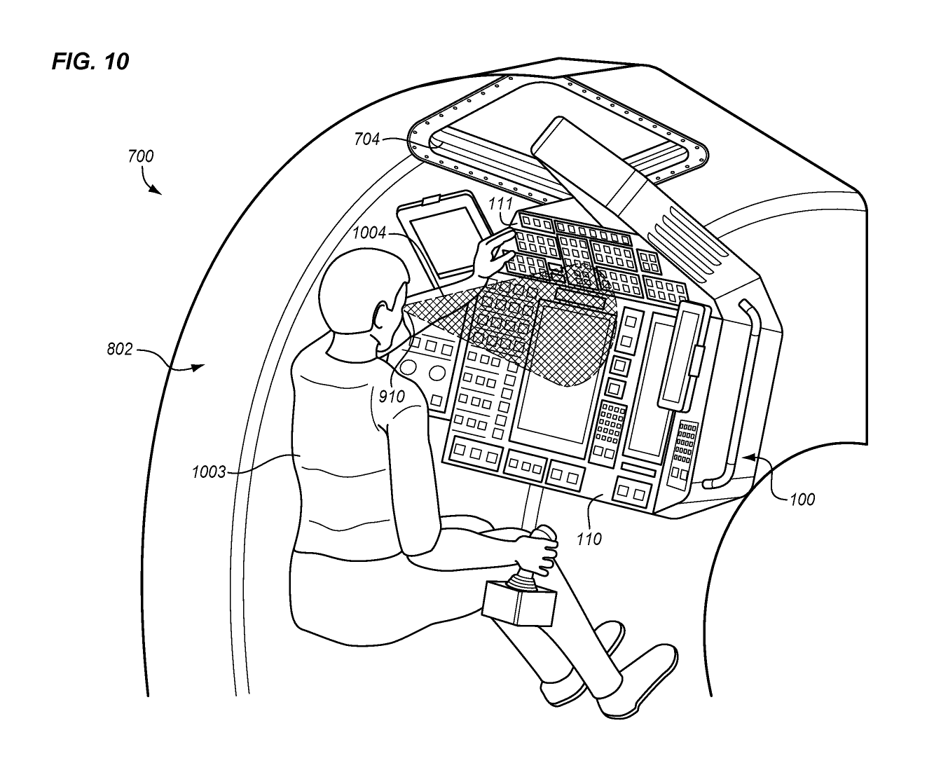

FIG. 10 is another view of the operator's compartment 802 in spacecraft 700 in an illustrative embodiment. This view is from behind and to the side of an operator 1003 that is sitting in seat 904 (not shown in FIG. 10). Operator 1003 is seated in front of instrument console 100, with his/her eyes aligned with DEP 910. At this position, the field of view or cone of vision 1004 of operator 1003 is directed onto primary mounting surface 110 (see FIG. 1) of instrument console 100. As is evident in FIG. 10, at least a portion of auxiliary mounting surface 111 may also be positioned within the cone of vision 1004 of operator 1003.

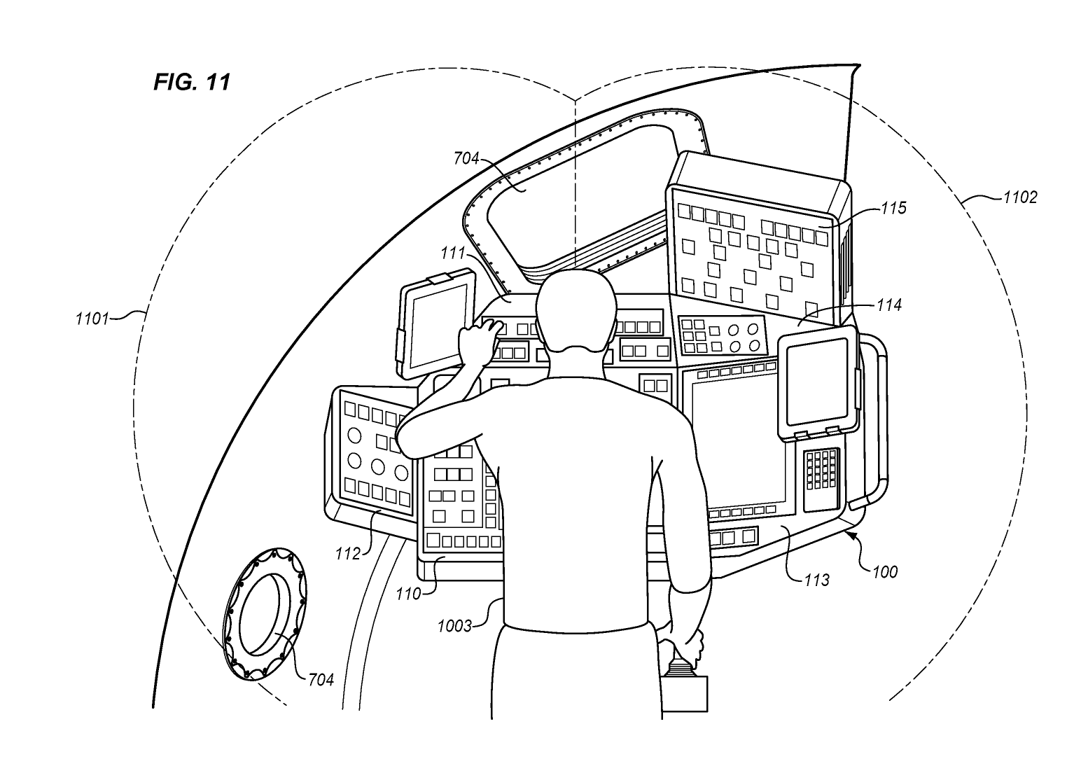

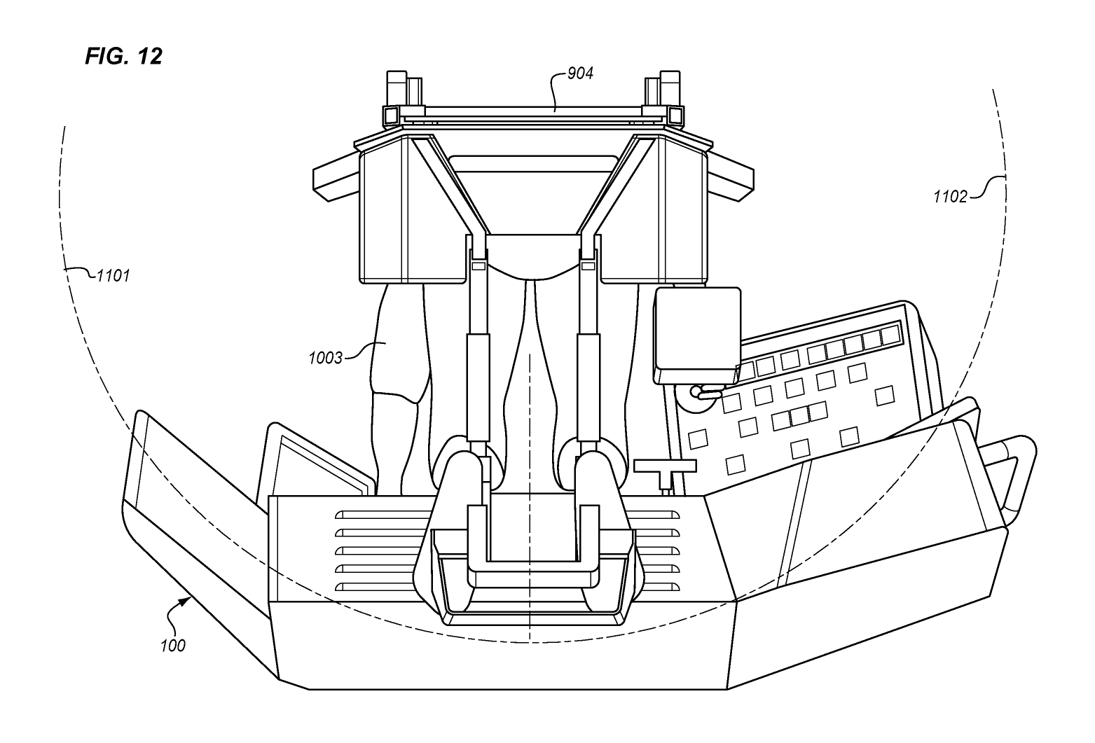

FIGS. 11-12 illustrate a reach of operator 1003 in relation to instrument console 100 in an illustrative embodiment. The view in FIG. 11 is from behind operator 1003. FIG. 11 shows the reach envelope 1101 of the left hand of operator 1003, and shows the reach envelope 1102 of the right hand of operator 1003. The view in FIG. 12 is from below operator 1003 when sitting in seat 904 to further illustrate the reach envelopes 1101-1102 of operator 1003. One technical benefit of the multifaceted design of instrument console 100 is that all control interfaces mounted on instrument console 100 are within reach of operator 1003. For instance, auxiliary mounting surfaces 112-113 are tilted inward at angles toward primary mounting surface 110 so that control interfaces mounted in/on auxiliary mounting surface 112 are within the reach envelope 1101 of operator 1003 and control interfaces mounted in/on auxiliary mounting surface 113 are within the reach envelope 1102 of operator 1003 (see FIG. 11). Auxiliary mounting surface 111 is tilted downward at an angle toward primary mounting surface 110 so that control interfaces mounted in/on auxiliary mounting surface 111 are within the reach envelope 1101 or the reach envelope 1102 of operator 1003. Auxiliary mounting surfaces 114-115 are tilted downward at an angle toward auxiliary mounting surface 113 so that control interfaces mounted in/on auxiliary mounting surfaces 114-115 are within the reach envelope 1102 of operator 1003. As spacecraft 700 may be used in high-G flight, it is beneficial that all control interfaces are within reach of operator 1003.

Although specific embodiments were described herein, the scope is not limited to those specific embodiments. Rather, the scope is defined by the following claims and any equivalents thereof.

What is claimed is:

1. An apparatus comprising:
an instrument console for a vehicle, the instrument console comprising:
a primary mounting surface positioned directly in front of an operator of the vehicle; and
a plurality of auxiliary mounting surfaces each being contiguous with the primary mounting surface or another one of the auxiliary mounting surfaces;
wherein each of the auxiliary mounting surfaces is angled with respect to a contiguous mounting surface toward the operator.

2. The apparatus of claim 1 wherein:
a first one of the auxiliary mounting surfaces is contiguous with a top side of the primary mounting surface; and
the instrument console further comprises an opening above the first one of the auxiliary mounting surfaces to provide a view of an external window of the vehicle to the operator.

3. The apparatus of claim 2 wherein:
a second one of the auxiliary mounting surfaces is contiguous with a left side of the primary mounting surface;
a third one of the auxiliary mounting surfaces is contiguous with a right side of the primary mounting surface;
a fourth one of the auxiliary mounting surfaces is contiguous with a top side of the third one of the auxiliary mounting surfaces; and
a fifth one of the auxiliary mounting surfaces is contiguous with a top side of the fourth one of the auxiliary mounting surfaces.

4. The apparatus of claim 3 wherein the instrument console further comprises:
priority control interfaces mounted on the primary mounting surface and the first one of the auxiliary mounting surfaces that are used for primary control of the vehicle; and
supplementary control interfaces mounted on second ones of the auxiliary mounting surfaces that are used for secondary functions of the vehicle as opposed to primary control.

5. The apparatus of claim 2 wherein:
a second one of the auxiliary mounting surfaces is contiguous with a right side of the primary mounting surface;
a third one of the auxiliary mounting surfaces is contiguous with a left side of the primary mounting surface;
a fourth one of the auxiliary mounting surfaces is contiguous with a top side of the third one of the auxiliary mounting surfaces; and
a fifth one of the auxiliary mounting surfaces is contiguous with a top side of the fourth one of the auxiliary mounting surfaces.

6. An instrument console for a vehicle, the instrument console comprising:
a plurality of console sections comprising:
a primary console section having a primary mounting surface positioned directly in front of an operator of the vehicle, and configured for mounting of priority control interfaces that are used for primary control of the vehicle;
a first auxiliary console section having a first auxiliary mounting surface contiguous with a top side of the primary mounting surface, and oriented at a first angle in relation to the primary mounting surface toward the operator;
a second auxiliary console section having a second auxiliary mounting surface contiguous with a first side of the primary mounting surface, and oriented at a second angle in relation to the primary mounting surface toward the operator;
a third auxiliary console section having a third auxiliary mounting surface contiguous with a second side of the primary mounting surface, and oriented at a third angle in relation to the primary mounting surface toward the operator;
a fourth auxiliary console section having a fourth auxiliary mounting surface contiguous with a top side of the third auxiliary mounting surface, and oriented at a fourth angle in relation to the third auxiliary mounting surface toward the operator; and
a fifth auxiliary console section having a fifth auxiliary mounting surface contiguous with a top side of the fourth auxiliary mounting surface, and oriented at a fifth angle in relation to the fourth auxiliary mounting surface toward the operator.

7. The instrument console of claim 6 wherein:
the first auxiliary mounting surface is configured for mounting of the priority control interfaces.

8. The instrument console of claim 7 wherein:
the primary mounting surface and at least a portion of the first auxiliary mounting surface are within a cone of vision of the operator.

9. The instrument console of claim 6 wherein:
the second auxiliary mounting surface, the third auxiliary mounting surface, the fourth auxiliary mounting surface, and the fifth auxiliary mounting surface are configured for mounting of supplementary control interfaces used for secondary functions of the vehicle as opposed to primary control.

10. The instrument console of claim 6 wherein:
the first angle between the first auxiliary mounting surface and the primary mounting surface is in a range of 35°±3°.

11. The instrument console of claim 6 wherein:
the second angle between the second auxiliary mounting surface and the primary mounting surface is in a range of 40°±3°.

12. The instrument console of claim 6 wherein:
the third angle between the third auxiliary mounting surface and the primary mounting surface is in a range of 20°±3°.

13. The instrument console of claim 6 wherein:
the fourth angle between the fourth auxiliary mounting surface and the third auxiliary mounting surface is in a range of 35°±3°.

14. The instrument console of claim 6 wherein:
the fifth angle between the fifth auxiliary mounting surface and the fourth auxiliary mounting surface is in a range of 30°±3°.

15. The instrument console of claim 6 further comprising:
an opening above the first auxiliary console section and to a side of the fifth auxiliary console section that exposes an external window of the vehicle.

16. The instrument console of claim 15 wherein:
a top border of the first auxiliary console section and a side border of the fifth auxiliary console section defines at least a portion of a boundary of the opening.

17. The instrument console of claim 6 wherein:
the vehicle comprises a spacecraft.

18. A spacecraft comprising:
a seat mounted in a compartment of the spacecraft;
an external window; and
an instrument console mounted in the compartment of the spacecraft, and having a plurality of mounting surfaces configured for mounting of control interfaces;
wherein the mounting surfaces include:
a primary mounting surface positioned directly in front of a Design Eye Point (DEP) of an operator sitting in the seat; and
a plurality of auxiliary mounting surfaces each being contiguous with the primary mounting surface or another one of the auxiliary mounting surfaces;
wherein each of the auxiliary mounting surfaces is angled with respect to a contiguous mounting surface toward the operator;
wherein the instrument console includes an opening that exposes the external window.

19. The spacecraft of claim 18 wherein:
the auxiliary mounting surfaces comprise:
a first auxiliary mounting surface contiguous with a top side of the primary mounting surface, and oriented at a first angle in relation to the primary mounting surface toward the operator;
a second auxiliary mounting surface contiguous with a first side of the primary mounting surface, and oriented at a second angle in relation to the primary mounting surface toward the operator;
a third auxiliary mounting surface contiguous with a second side of the primary mounting surface, and oriented at a third angle in relation to the primary mounting surface toward the operator;
a fourth auxiliary mounting surface contiguous with a top side of the third auxiliary mounting surface, and oriented at a fourth angle in relation to the third auxiliary mounting surface toward the operator; and
a fifth auxiliary mounting surface contiguous with a top side of the fourth auxiliary mounting surface, and oriented at a fifth angle in relation to the fourth auxiliary mounting surface toward the operator.

20. The spacecraft of claim 19 wherein:
the opening is above the first auxiliary mounting surface and to a side of the fifth auxiliary mounting surface to expose the external window.
